(19) United States
(12) Patent Application Publication
(10) Pub. No.: US 2022/0352652 A1
(43) Pub. Date: Nov. 3, 2022

(54) WELDED BODY MANUFACTURING METHOD AND WELDED BODY

(71) Applicant: YAZAKI CORPORATION, Tokyo (JP)

(72) Inventor: Takahiro Yudate, Makinohara-shi (JP)

(21) Appl. No.: 17/728,989

(22) Filed: Apr. 26, 2022

(30) Foreign Application Priority Data
Apr. 28, 2021 (JP) 2021-076229

(51) Int. Cl. H01R 4/62; H01R 11/12; H01R 43/02; B23K 20/10

(52) U.S. Cl. CPC H01R 4/625; H01R 11/12; H01R 43/0207; B23K 20/10; B23K 2101/36

(57) ABSTRACT

A welded body manufacturing method for a welded body in which a terminal formed of a metal base material and plated with a metal material having a hardness lower than a hardness of the metal base material is connected to an end portion of a conductive member, the conductive member being connected to the terminal on a conductor welding surface of the terminal is provided. The manufacturing method includes forming at least one of a convex portion and a concave portion on the conductor welding surface and connecting the conductive member to the conductor welding surface by means of ultrasonic welding.

The present application claims priority to Japanese Patent Application No. 2021-076229 filed on Apr. 28, 2021, the entire content of which is incorporated herein by reference.

### TECHNICAL FIELD

The presently disclosed subject matter relates to a welded body manufacturing method and a welded body.

### BACKGROUND

When manufacturing a terminal-equipped electric wire in which a terminal is connected to a core wire exposed from an end of an electric wire, the core wire and the terminal are integrally connected by ultrasonic welding by pressing the core wire against the terminal and applying ultrasonic vibration.

The terminal is often tin-pleated as a surface treatment from the viewpoint of corrosion protection and reliability of contact, but when the core wire of the electric wire is welded by the ultrasonic welding, since the tin plating having a low hardness is interposed, welding becomes unstable, and sufficient connection strength cannot be obtained.

Therefore, in the related art, a portion of a terminal excluding a connection surface with a core wire is tin-plated, and the core wire is connected to the connection surface where a base material of the terminal is exposed (see JP2005-108608A, for example). In addition, in another related art, it is shown that a terminal is subjected to nickel plating at a connection part with a core wire, and is tin-plated at an electrical contact portion that contacts a bolt (JP6616058B2).

### SUMMARY

According to the related art described above, it is possible to achieve both reliability such as corrosion prevention and stable ultrasonic welding, but it is necessary to perform the tin plating by masking the connection part with respect to the core wire or to perform a plurality of different plating processing, which is troublesome to manufacture and increases manufacturing cost.

Illustrative aspects of the presently disclosed subject matter provide a welded body manufacturing method and a welded body in which it is easy to connect a terminal plated with a metal material and a conductive member, such as a core wire of an electric wire, to each other by ultrasonic welding while reducing manufacturing cost.

According to an illustrative aspect of the presently disclosed subject matter, a welded body manufacturing method for a welded body in which a terminal formed of a metal base material and plated with a metal material having a hardness lower than a hardness of the metal base material is connected to an end portion of a conductive member, the conductive member being connected to the terminal on a conductor welding surface of the terminal is provided. The manufacturing method includes forming at least one of a convex portion and a concave portion on the conductor welding surface and connecting the conductive member to the conductor welding surface by means of ultrasonic welding.

According to another illustrative aspect of the presently disclosed subject matter, a welded body includes a terminal formed of a metal base material and having a conductor welding surface on which at least one of a convex portion and a concave portion is formed, the terminal being plated with a metal material having a hardness lower than a hardness of the metal base material and a conductive member welded and connected to the conductor welding surface of the terminal.

Other aspects and advantages of the presently disclosed subject matter will be apparent from the following description, the drawings and the claims.

### BRIEF DESCRIPTION OF DRAWINGS

FIG. 1 is a perspective view of a terminal-equipped electric wire, which is a welded body according to the present embodiment;

FIGS. 2A and 2B are views showing the terminal-equipped electric wire that is the welded body according to the present embodiment, in which FIG. 2A is a plan view of a terminal portion, and FIG. 2B is a cross-sectional view taken along an axial direction of an electric wire at an electric wire connection portion of a terminal;

FIGS. 3A and 3B are views of a terminal-equipped electric wire manufacturing method in which the terminal-equipped electric wire is the welded body, in which FIG. 3A is a plan view of the terminal in a forming step, and FIG. 3B is a plan view of the terminal portion in a connecting step;

FIGS. 4A and 4B are views of the terminal-equipped electric wire manufacturing method in which the terminal-equipped electric wire is the welded body, in which FIG. 4A is a cross-sectional view of the electric wire connection portion of the terminal after the forming step, and FIG. 4B is a cross-sectional view of the electric wire connection portion of the terminal after a plating step;

FIGS. 5A and 5B are views showing the connecting step in the terminal-equipped electric wire manufacturing method in which the terminal-equipped electric wire is the welded body, in which FIG. 5A is a cross-sectional view of a welding portion between the terminal and a core wire before welding (i.e., connecting), and FIG. 5B is a cross-sectional view of the welding portion between the terminal and the core wire at the time of welding;

FIGS. 6A to 6C are views showing a welded body manufacturing method according to another embodiment, in which FIG. 6A is a cross-sectional view of the electric wire connection portion of the terminal after a reflow step. FIG. 6B is a cross-sectional view of the welding portion between the terminal and the core wire before welding in the connecting step, and FIG. 6C is a cross-sectional view of the welding portion between the terminal and the core wire at the time of welding in the connecting step;

FIGS. 7A to 7C are views showing modifications of the terminal having other convex portions, and FIGS. 7A to 7C are plan views of the terminal;

FIGS. 8A and 8B are views showing the convex portion having other cross-sectional shapes, in which FIG. 8A is a schematic cross-sectional view of the terminal provided with a trapezoidal convex portion, and FIG. 8B is a schematic cross-sectional view of the terminal provided with the convex portion having an arc-shaped top portion;

FIG. 9 is a schematic cross-sectional view of the terminal provided with a concave portion; and

FIGS. 10A and 10B are views showing the welded body in which another conductive member is welded to the terminal, in which FIG. 10A is a perspective view of the welded body in which a braided wire is welded to the terminal, and FIG. 10B is a perspective view of the welded body in which a conductive plate is welded to the terminal.

### DESCRIPTION OF EMBODIMENTS

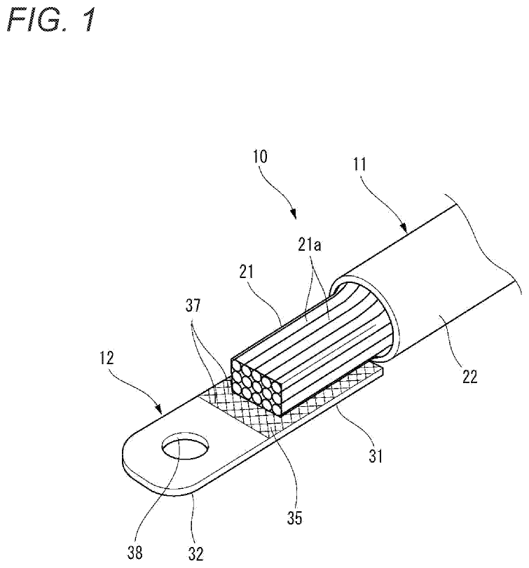

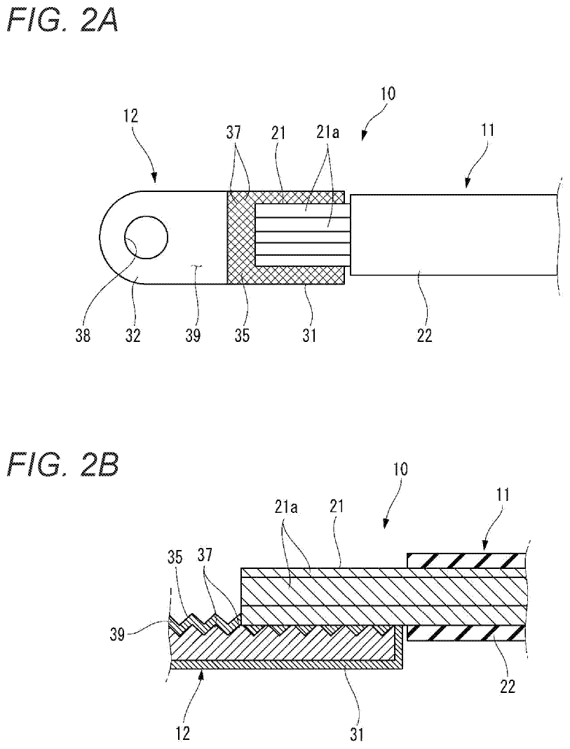

Hereinafter, embodiments of the presently disclosed subject matter will be described with reference to the drawings. FIG. 1 is a perspective view of a terminal-equipped electric wire that is a welded body according to the present embodiment. FIGS. 2A and 2B are views showing the terminal-equipped electric wire that is the welded body according to the present embodiment, in which FIG. 2A is a plan view of a terminal portion, and FIG. 2B is a cross-sectional view taken along an axial direction of an electric wire at an electric wire connection portion of a terminal.

As shown in FIGS. 1, 2A, and 2B, a terminal-equipped electric wire 10 includes an electric wire 11 and a terminal 12 connected to an end portion of the electric wire 11. In this example, the terminal-equipped electric wire 10 in which the terminal 12 is connected to the end portion of the electric wire 11 is described as an example of a welded body.

The electric wire 11 is an insulated electric wire having a core wire (conductive member) 21 and an outer cover 22 that covers the core wire 21. The core wire 21 is formed, for example, by bundling a plurality of wires 21a made of a conductive metal material such as copper, a copper alloy, aluminum or an aluminum alloy. The outer cover 22 is made of a resin material having flexibility and insulating property. In the end portion of the electric wire 11, the outer cover 22 is removed to expose a part of the core wire 21. When the core wire 21 is formed of a plurality of wires 21a made of copper or a copper alloy, each of the wires 21a may be plated with tin, nickel, silver gold, or the like.

The terminal 12 is formed by processing a plate material made of the conductive metal material. In this example, the terminal 12 is formed by processing the plate material made of pure copper. The terminal 12 is formed in a flat plate shape, and includes an electric wire connection portion 31 and an electrical connection portion 32.

One surface of the electric wire connection portion 31 of the terminal 12 is a conductor welding surface 35, and the core wire 21 of the electric wire 11 is welded (i.e., connected) to the conductor welding surface 35. The core wire 21 of the electric wire 11 is welded to the conductor welding surface 35 of the electric wire connection portion 31 by ultrasonic welding. Accordingly, the terminal 12 and the core wire 21 of the electric wire 11 are electrically connected.

A plurality of convex portions 37 are formed on the conductor welding surface 35 to which the core wire 21 is welded. These convex portions 37 are formed such that the plurality of linear convex portions 37 disposed at equal intervals to each other extend orthogonal to each other, and are arranged in a grid pattern. Each of the convex portions 37 arranged in the grid pattern extends in directions intersecting a longitudinal direction of the core wire 21 of the electric wire 11 with respect to the core wire 21 welded to the conductor welding surface 35.

The electrical connection portion 32 of the terminal 12 has a hole 38 penetrating a front and back. The electrical connection portion 32 is to be electrically connected by being fastened and fixed to a portion such as various devices with a fastener such as a bolt or a screw in the hole 38.

An entirety of the terminal 12 having the electric wire connection portion 31 and the electrical connection portion 32 is plated with a metal material having a hardness lower than a hardness of a metal base material of the terminal 12. In this example, in the terminal 12, the metal base material made of pure copper (Vickers hardness Hv 65 to Hv 80) is subjected to tin plating (Vickers hardness Hv 5 to Hv 40) having a hardness lower than the hardness of the metal base material. Accordingly, the entire terminal 12 is covered with a tin plate layer 39 to be protected from corrosion, and reliability of electrical connection with the connection target portion such as a device or the like is obtained.

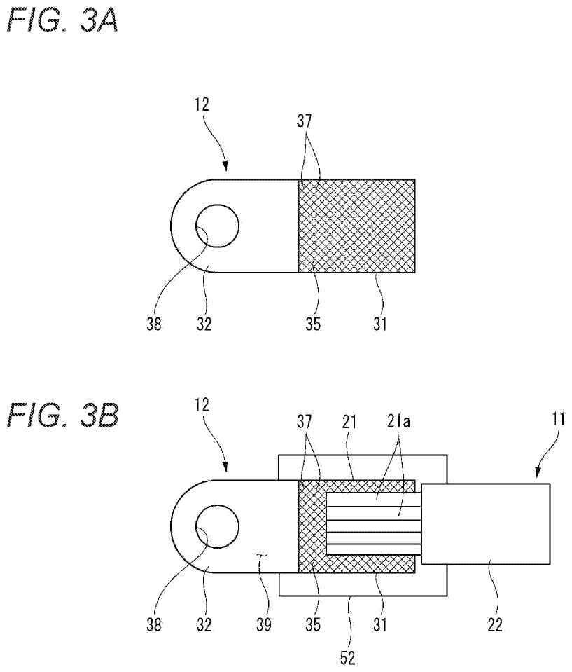

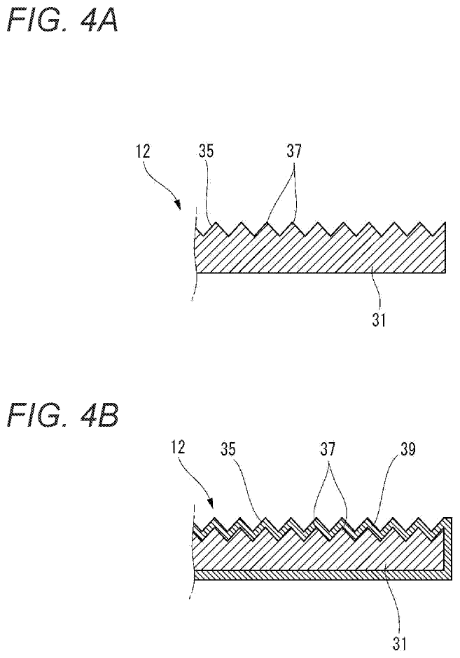

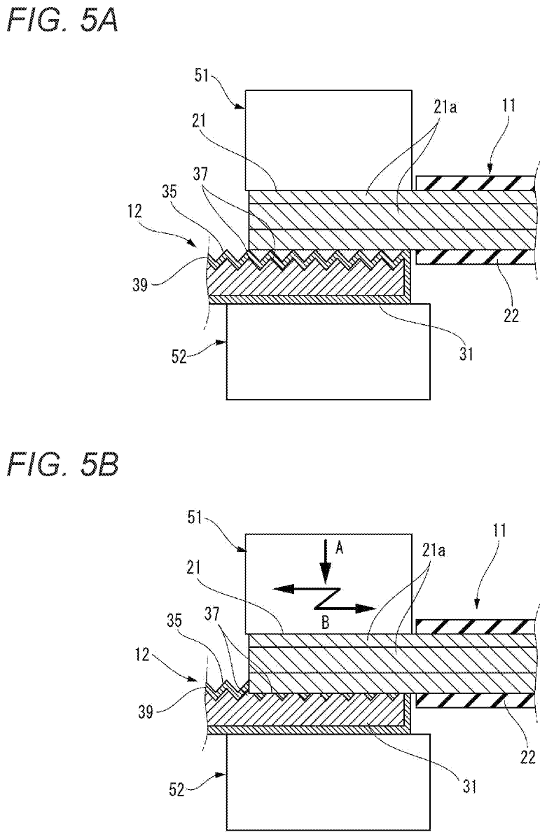

Next, a terminal-equipped electric wire 10 manufacturing method will be described, in which the terminal-equipped electric wire 10 is the welded body according to the present embodiment. FIGS. 3A and 3B are views of the terminal-equipped electric wire manufacturing method in which the terminal-equipped electric wire is the welded body, in which FIG. 3A is a plan view of the terminal in a forming step, and FIG. 3B is a plan view of the terminal portion in a connecting step. FIGS. 4A and 4B are views of the terminal-equipped electric wire manufacturing method in which the terminal-equipped electric wire is the welded body, in which FIG. 4A is a cross-sectional view of the electric wire connection portion of the terminal after the forming step, and FIG. 4B is a cross-sectional view of the electric wire connection portion of the terminal after a plating step. FIGS. 5A and 5B are views showing the connecting step in the terminal-equipped electric wire manufacturing method in which the terminal-equipped electric wire is the welded body, in which FIG. 5A is a cross-sectional view of a welding portion between the terminal and the core wire before welding (i.e., connecting), and FIG. 5B is a cross-sectional view of the welding portion between the terminal and the core wire at the time of welding.

As shown in FIGS. 3A and 4A, a plurality of convex portions 37 are formed on the conductor welding surface 35 of the terminal 12. In this example, the linear convex portions 37 provided at equal intervals to each other extending in directions intersecting the longitudinal direction of the core wire 21 to be welded extend orthogonal to each other and are formed in the grid pattern. The convex portions 37 can be molded (i.e., formed) at the same time when the terminal 12 is molded by press working. The convex portion 37 of the conductor welding surface 35 can be easily obtained by molding a knurl, an indent, a serration, or the like by, for example, pattern transfer processing using a mold, embossing, bending and molding, or the like.

Next, the terminal 12 is subjected to a tin plating processing. At this time, by immersing the terminal 12 in plating solution of a tin plating tank, the entire terminal 12 including the conductor welding surface 35 is tin-plated. Accordingly, the tin plate layer 39 that covers the entire terminal 12 is formed. Thus, when the entire terminal 12 is subjected to the tin plating, as shown in FIG. 4B, on the conductor welding surface 35 on which the plurality of convex portions 37 are formed, the respective convex portions 37 are covered by the tin plate layer 39. On the conductor welding surface 35, the tin plate layer 39 is formed in a layer shape following the plurality of convex portions 37, and has a surface shape having a plurality of convex parts similar to the convex portions 37. In addition, by performing the tin plating on the entire terminal 12 including the conductor welding surface 35, the terminal 12 is covered with the tin plate layer 39 on front and back surfaces, an entire peripheral surface, and an inner peripheral surface of the hole 38 of the electrical connection portion 32, and a base material, which is an underlying metal, is not exposed.

As shown in FIGS. 3B and 5A, at the end portion of the electric wire 11, a part of the outer cover 22 is removed to expose the core wire 21, and the terminal 12 and the core wire 21 of the electric wire 11 are set in an ultrasonic welding device including a horn 51 and an anvil 52. Specifically, the electric wire connection portion 31 of the terminal 12 and the core wire 21 of the electric wire 11 are overlapped with each other and disposed between the horn 51 and the anvil 52 forming the ultrasonic welding device, and the core wire 21 is placed on the conductor welding surface 35 of the electric wire connection portion 31.

The horn 51 of the ultrasonic welding device includes a vibrator (not shown) that causes ultrasonic vibration by feeding an alternating current, and is vibrated by the vibrator. The terminal 12 and the core wire 21 that are placed on the anvil 52 and disposed between the horn 51 and the anvil 52 are sandwiched between the horn 51 and the anvil 52 by a load from the horn 51.

After the terminal 12 and the core wire 21 are disposed between the horn 51 and the anvil 52, as shown in FIG. 5B, the horn 51 is moved toward the anvil 52 (toward an arrow A direction in FIG. 5B). Accordingly, the horn 51 and the anvil 52 sandwich the terminal 12 and the core wire 21 in a pressed manner. In this state, the alternating current is supplied to the vibrator. Then, the horn 51 is ultrasonically vibrated in a horizontal direction (an arrow B direction in FIG. 5B) by the vibrator, so that ultrasonic vibration energy is propagated to the terminal 12 and the core wire 21, and the core wire 21 of the electric wire 11 is ultrasonically welded to the conductor welding surface 35 of the terminal 12 to be welded. Accordingly, the terminal-equipped electric wire 10 in which the electric wire 11 is connected to the terminal 12 is obtained. A direction of the applied ultrasonic vibration is not limited as long as the ultrasonic vibration is along the welding portion between the terminal 12 and the core wire 21.

As shown in FIG. 5B, when the electric wire connection portion 31 having the conductor welding surface 35 on which the plurality of convex portions 37 are formed and the core wire 21 of the electric wire 11 are pressed against each other by applying the ultrasonic vibration, the convex portion 37 formed of the metal base material made of pure copper, which has a hardness higher than a hardness of the tin plate layer 39, gets into the tin plate layer 39 between the convex portion 37 and the core wire 21 due to a high pressure. Accordingly, tin forming the tin plate layer 39 between the convex portion 37 and the core wire 21 is pushed out toward the periphery of each convex portion 37, and the convex portion 37 contacts the core wire 21 with a high pressure and is welded. Therefore, the base material of the terminal 12 and the core wire 21 of the electric wire 11 are favorably ultrasonically welded without being hindered by the tin plating applied to the entire terminal 12.

As described above, according to a welded body manufacturing method according to the present embodiment, by applying the ultrasonic vibration in the connecting step, the convex portion 37 gets into the tin plating due to a high pressure, and contacts the core wire 21 of the electric wire 11. Therefore, the metal base material of the terminal 12 and the core wire 21 of the electric wire 11 can be favorably ultrasonically welded with respect to the terminal 12 that is entirely subjected to the tin plating without masking a connection part with the core wire 21 or without performing a plurality of different plating processing. Accordingly, it is possible to easily manufacture the welded body including the terminal-equipped electric wire 10 in which the terminal 12 tin-plated is connected to the electric wire 11 while reducing manufacturing cost. In addition, since the tin plating is applied to the entire terminal 12, good corrosion resistance and reliability of electrical connection of the terminal 12 can be obtained.

In addition, by molding the linear convex portion 37 extending in the directions intersecting the longitudinal direction of the core wire 21, when the ultrasonic vibration is applied in the connecting step, the convex portion 37 can be more favorably brought into contact with the core wire 21 and welded to the core wire 21.

According to the welded body formed of the terminal-equipped electric wire 10 manufactured by this manufacturing method, since the tin plating is applied to the entire terminal 12, good corrosion resistance and reliability of electrical connection of the terminal 12 can be obtained. In addition, since the plurality of convex portions 37 are formed on the conductor welding surface 35, the terminal-equipped electric wire 10 in which the convex portion 37 of the conductor welding surface 35 is firmly welded to the core wire 21 of the electric wire 11 by the ultrasonic welding can be obtained. Formation of the convex portion 37 on the conductor welding surface 35 can be easily confirmed by visually observing the conductor welding surface 35 around the welding portion with the core wire 21.

In the above embodiment, a case where the plating step is performed in which the terminal 12 is subjected to the tin plating processing after forming the convex portion 37 on the conductor welding surface 35 is shown, but the plating step of performing the tin plating may be performed before the convex portion 37 is formed on the conductor welding surface 35 by the forming step. Specifically, the tin plating may be performed in a state of the terminal 12 as a conductive metal plate (pre-plating), or the tin plating may be performed after the conductive metal plate is molded into a blank panel to be the terminal 12 or after a blank panel is molded into the terminal 12.

A thickness of the tin plate layer 39 formed on a surface of the terminal 12 is preferably 20 μm or less. A height of the convex portion 37 on the conductor welding surface 35 is preferably higher than the thickness of the tin plate layer 39.

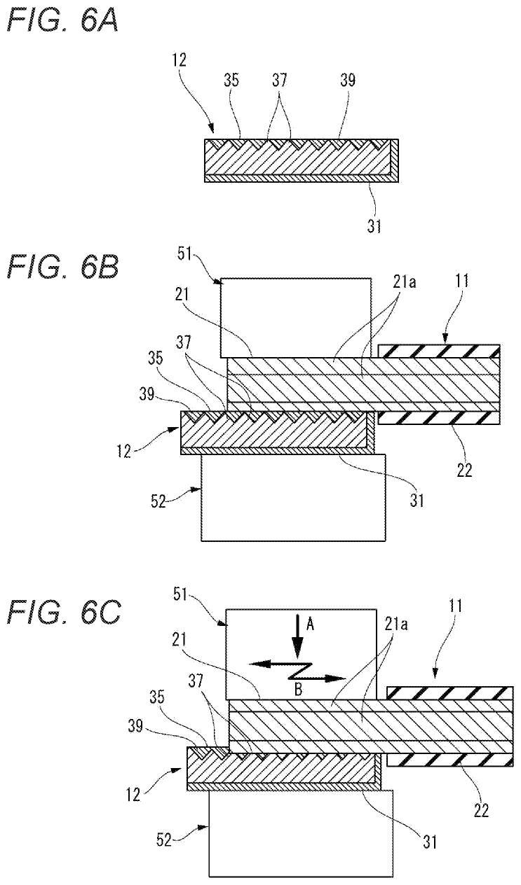

Next, the terminal-equipped electric wire manufacturing method according to another embodiment will be described, in which the terminal-equipped electric wire is the welded body. The same components as those in the above-described embodiment are denoted by the same reference signs, and description thereof is omitted. FIGS. 6A to 6C are views showing the welded body manufacturing method according to another embodiment, in which FIG. 6A is a cross-sectional view of the electric wire connection portion of the terminal after a reflow step, FIG. 6B is a cross-sectional view of the welding portion between the terminal and the core wire before welding in the connecting step, and FIG. 6C is a cross-sectional view of the welding portion between the terminal and the core wire at the time of welding in the connecting step.

In the terminal-equipped electric wire manufacturing method according to another embodiment in which the terminal-equipped electric wire is the welded body, after the entire terminal 12 including the conductor welding surface 35 is subjected to the tin plating in the plating step, the reflow step is performed in which a reflow processing is performed on the tin-plated terminal 12 (see FIG. 4B). Specifically, the entire terminal 12 which has been tin-plated is heated to melt the tin plate layer 39 first and then cool the tin plate layer 39.

As shown in FIG. 6A, when the tin-plated terminal 12 is subjected to the reflow processing, tin of the tin plate layer 39 is temporarily melted, so that the tin plating is leveled and flattened on the conductor welding surface 35 of the terminal 12. Accordingly, a thickness of the tin plating at a top portion of the convex portion 37 is reduced.

Therefore, as shown in FIG. 6B, in a state where the terminal 12 and the core wire 21 of the electric wire 11 are overlapped and disposed between the horn 51 and the anvil 52, the top portion of the convex portion 37 on the conductor welding surface 35 and the core wire 21 are already in close proximity to each other.

Then, in this state, when the terminal 12 and the core wire 21 are sandwiched between the horn 51 and the anvil 52 and the horn 51 is ultrasonically vibrated, as shown in FIG. 6C, the plurality of convex portions 37 contacts the core wire 21 of the electric wire 11 without being hindered by the tin plating. Therefore, the base material of the terminal 12 and the core wire 21 of the electric wire 11 can be ultrasonically welded more favorably.

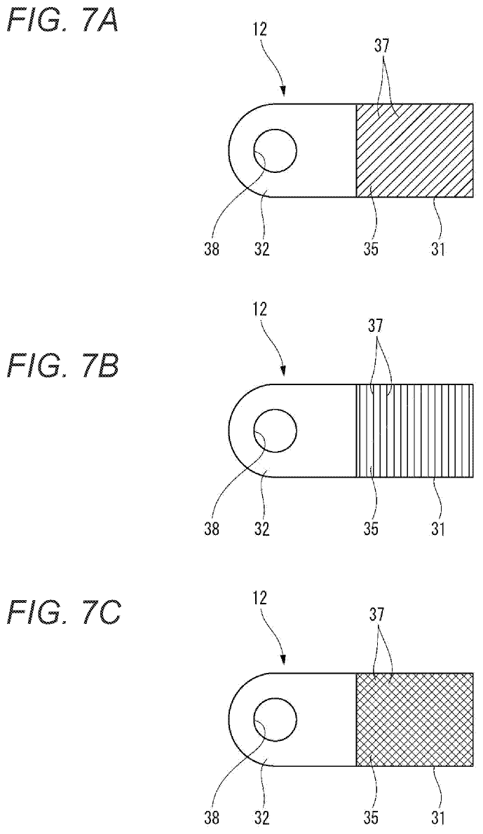

The convex portion 37 formed on the conductor welding surface 35 of the terminal 12 is not limited to that of the above-described embodiment. For example, as shown in FIG. 7A, on the conductor welding surface 35, the linear convex portions 37 may be formed at equal intervals extending in an oblique direction intersecting the longitudinal direction of the core wire 21 disposed on an upper face of the conductor welding surface 35. In addition, as shown in FIG. 7B, on the conductor welding surface 35, the linear convex portions 37 may be formed at equal intervals extending in a width direction orthogonal to the longitudinal direction of the core wire 21 disposed on the upper face of the conductor welding surface 35. Further, as shown in FIG. 7C, a plurality of point-shaped convex portions 37 protruding from the conductor welding surface 35 may be formed.

In the above embodiment, as a cross-sectional shape of the convex portion 37, a case of a mountain shape that points upward is shown, but the cross-sectional shape of the convex portion 37 is not limited to the mountain shape.

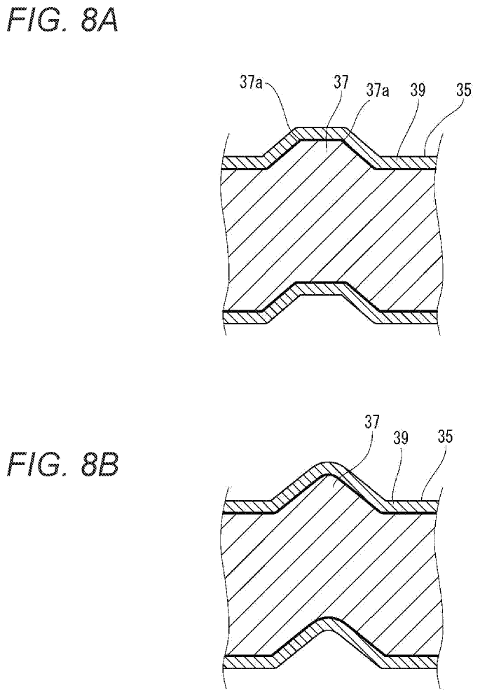

Here, the convex portion 37 having another cross-sectional shape will be described. FIGS. 8A and 8B are views showing the convex portion having other cross-sectional shapes, in which FIG. 8A is a schematic cross-sectional view of the terminal provided with a trapezoidal convex portion, and FIG. 8B is a schematic cross-sectional view of the terminal provided with the convex portion having an arc-shaped top portion. As shown in FIG. 8A, the cross-sectional shape of the convex portion 37 may be a trapezoidal shape. Thus, in the case of the trapezoidal convex portion 37, an edge 37a, is formed on an upper portion of the convex portion 37. In the trapezoidal convex portion 37, the edge 37a of the convex portion 37 gets into the tin plate layer 39 with a high pressure by applying the ultrasonic vibration in the connecting step. Accordingly, tin forming the tin plate layer 39 between the convex portion 37 and the core wire 21 is pushed out toward the periphery of each convex portion 37, and the convex portion 37 contacts the core wire 21 with a high pressure to be welded.

In addition, as shown in FIG. 8B, as for the cross-sectional shape of the convex portion 37, the top portion of the convex portion 37 may be formed in an arc shape. Thus, even when the top portion of the convex portion 37 has an arc shape, the arc-shaped top portion of the convex portion 37 gets into the tin plate layer 39 at a high pressure by applying the ultrasonic vibration in the connecting step. Accordingly, tin forming the tin plate layer 39 between the convex portion 37 and the core wire 21 is pushed out toward the periphery of each convex portion 37, and the convex portion 37 contacts the core wire 21 with a high pressure to be welded.

In addition, in the above embodiment, a case where the convex portion is formed on the conductor welding surface 35 is shown, but a concave portion may be formed on the conductor welding surface 35, and further both the convex portion and the concave portion may be formed on the conductor welding surface 35.

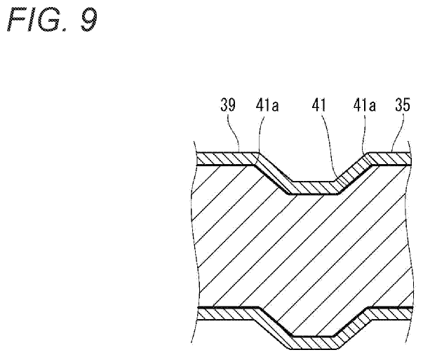

FIG. 9 is a schematic cross-sectional view of the terminal provided with the concave portion. As shown in FIG. 9, for example, when a groove-shaped concave portion 41 is molded on the conductor welding surface 35, an edge 41a is formed in an edge portion of the concave portion 41 in a cross-sectional view. In the conductor welding surface 35 on which the concave portion 41 is molded, when the core wire 21 is ultrasonically welded, the tin plate layer 39 is sandwiched between the edge 41a of the concave portion 41 and the core wire 21, and stress is concentrated in this portion. Therefore, the tin plating that receives the concentrated stress is pushed into the concave portion 41 in cooperation with the ultrasonic vibration along the longitudinal direction of the terminal 12, and the base material of the terminal 12 is preferentially exposed during the welding in the vicinity of the edge 41a. Therefore, an exposed portion of the base material of the terminal 12 and the core wire 21 can be favorably ultrasonically welded.

The conductive member to be welded to the terminal 12 in the present embodiment is not limited to the core wire 21 of the electric wire 11.

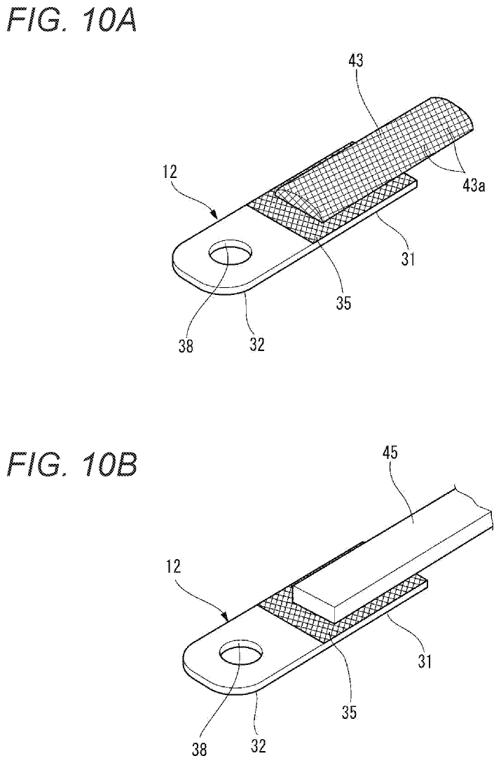

FIGS. 10A and 10B are views showing the welded body in which another conductive member is welded to the terminal, in which FIG. 10A is a perspective view of the welded body in which a braided wire is welded to the terminal, and FIG. 10B is a perspective view of the welded body in which a conductive plate is welded to the terminal.

The welded body shown in FIG. 10A is the welded body obtained by ultrasonically welding a braided wire 43 formed by weaving a plurality of wires 43a made of the conductive metal material such as copper, a copper alloy, aluminum, or an aluminum alloy to the conductor welding surface 35 of the terminal 12. In addition, the welded body shown in FIG. 10B is the welded body obtained by ultrasonically welding a long conductive plate 45 made of the conductive metal material such as copper, a copper alloy, aluminum, or an aluminum alloy to the conductor welding surface 35 of the terminal 12.

Thus, even when the braided wire 43 or the conductive plate 45 is welded to the conductor welding surface 35, since at least one of the convex portion 37 and the concave portion 41 is molded on the conductor welding surface 35, the braided wire 43 or the conductive plate 45 can be favorably ultrasonically welded to the terminal 12, entirety of which has been tin-plated. Accordingly, the welded body having high connection reliability in which the tin-plated terminal 12 is connected to the braided wire 43 or the conductive plate 45 can be easily manufactured while reducing the manufacturing cost.

In addition, the terminal 12 may be provided an outer cover crimping portion that crimps the outer cover 22 of the electric wire 11 to the electric wire connection portion 31. The terminal 12 may be a female terminal or a male terminal having a welding portion in which the electrical connection portion 32 is to be attached to and detached from a counterpart terminal. For example, when the terminal 12 is the female terminal, a box type welding portion having a spring contact is provided inside, and a plate-shaped tab of a counterpart male terminal is inserted thereinto, so that the spring contact elastically contacts the tab and is electrically connected to the tab. In addition, when the terminal 12 is the male terminal, a welding portion having the plate-shaped tab that is to be inserted into the box type welding portion of a counterpart female terminal to be electrically connected is provided.

In the above embodiment, the terminal 12 in which the metal base material made of pure copper is subjected to tin plating having the hardness lower than the hardness of the metal base material is described as an example, but a combination of the metal base material and the metal plating is not limited to pure copper and the tin plating as long as a condition that the metal plating has a hardness lower than the hardness of the metal base material is satisfied.

For example, the metal base material may be brass (Vickers hardness Hv 80 to Hv 200) or another copper alloy (Vickers hardness Hv 85 to Hv 200) in addition to pure copper. Then, metal plating such as tin (Sn), silver (Ag), or gold (Au) may be applied to the metal base material such as pure copper, brass, or another copper alloy so as to satisfy the condition that the metal plating has the hardness lower than the hardness of the metal base material.

While the presently disclosed subject matter has been described with reference to certain exemplary embodiments thereof, the scope of the presently disclosed subject matter is not limited to the exemplary embodiments described above, and it will be understood by those skilled in the art that various changes and modifications may be made therein without departing from the scope of the presently disclosed subject matter as defined by the appended claims.

According to an aspect of the embodiments described above, a welded body manufacturing method for a welded body in which a terminal (12) formed of a metal base material and plated with a metal material having a hardness lower than a hardness of the metal base material is connected to an end portion of a conductive member (for example, a core wire 21, braided wire 43, conductive plate 45), the conductive member being connected to the terminal (12) on a conductor welding surface (35) of the terminal (12) is provided. The manufacturing method includes forming at least one of a convex portion (37) and a concave portion (41) on the conductor welding surface (35) and connecting the conductive member (core wire 21, braided wire 43, conductive plate 45) to the conductor welding surface (35) by means of ultrasonic welding.

According to the welded body manufacturing method having a configuration explained above, by applying ultrasonic vibration in the connecting step, a top portion of the convex portion or an edge portion of the concave portion gets into the metal plating having the hardness lower than the hardness of the metal base material at a high pressure, and contacts the conductive member. Therefore, a base material of the terminal and the conductive member can be favorably ultrasonically welded with respect to the terminal subjected to the metal plating without masking a connection part with the conductive member or without performing a plurality of different plating processing. Accordingly, the welded body in which the terminal subjected to the metal plating is connected to the conductive member can be easily manufactured while reducing manufacturing cost. In addition, since the metal plating is applied to the terminal, good corrosion resistance and reliability of electrical connection of the terminal can be obtained.

The metal base material may be tin-plated.

With this configuration, by applying the ultrasonic vibration in the connecting step, the top portion of the convex portion or the edge portion of the concave portion gets into the tin plating at a high pressure, and contacts the conductive member. In addition, since the tin plating is applied to the terminal, good corrosion resistance and reliability of electrical connection of the terminal can be obtained.

The welded body manufacturing method may further include plating an entirety of the terminal (12) after the forming.

With this configuration, the entire terminal is covered with the metal plating by the plating processing performed after the forming step, and good corrosion resistance and reliability of electrical connection can be obtained.

The welded body manufacturing method may further include performing a reflow processing on the terminal (12) before the connecting.

With this configuration, the terminal is subjected to the reflow processing before the connecting step, so that the metal plating on the conductor welding surface on which at least one of the convex portion and the concave portion is formed can be smoothed, and a thickness of the metal plating on the top portion of the convex portion or around the concave portion can be reduced. Accordingly, by applying the ultrasonic vibration in the connecting step, the top portion of the convex portion and the edge portion of the concave portion can be more easily brought into contact with the conductive member, and the base material of the terminal and the conductive member can he favorably ultrasonically welded.

The conductive member may be a core wire (21) of an electric wire (11), the core wire (21) being covered with an outer cover (22).

With this configuration, it is possible to easily manufacture the welded body including the terminal-equipped electric wire in which the core wire of the electric wire is welded to the conductor welding surface of the terminal while reducing the manufacturing cost.

The at least one of the convex portion (37) and the concave portion (41) may he formed in a linear shape extending in a direction intersecting a longitudinal direction of the core wire (21).

With this configuration, by forming at least one of the linear convex portion and concave portion extending in the direction intersecting the longitudinal direction of the core wire, when the ultrasonic vibration is applied in the connecting step, the top portion of the convex portion or the edge portion of the concave portion can be more favorably brought into contact with the core wire and welded to the core wire.

According to another aspect of the embodiments described above, a welded body includes a terminal (12) formed of a metal base material and having a conductor welding surface (35) on which at least one of a convex portion (37) and a concave portion (41) is formed, the terminal (12) being plated with a metal material having a hardness lower than a hardness of the metal base material and a conductive member (for example, a core wire 21, braided wire 43, conductive plate 45) welded and connected to the conductor welding surface (35) of the terminal (12).

According to the welded body having a configuration explained above, since the metal plating is applied to the terminal, good corrosion resistance and reliability of electrical connection of the terminal can be obtained. In addition, since at least one of a plurality of convex portions and concave portions is formed on the conductor welding surface, for example, when the conductive member is welded to the conductor welding surface by ultrasonic welding or the like, it is possible to form the welded body in which a top portion of the convex portion or an edge portion of the concave portion gets into the metal plating having the hardness lower than the hardness of the metal base material and is firmly welded to the conductive member.

The metal base material may be tin-plated.

With this configuration, since the tin plating is applied to the terminal, good corrosion resistance and reliability of electrical connection of the terminal can be obtained.

The conductive member may be a core wire (21) covered with an outer cover (22).

With this configuration, since the metal plating is applied to the terminal, it is possible to form the welded body including a terminal-equipped electric wire in which good corrosion resistance and reliability of electrical connection of the terminal can be obtained.

What is claimed is:

1. A welded body manufacturing method for a welded body in which a terminal formed of a metal base material and plated with a metal material having a hardness lower than a hardness of the metal base material is connected to an end portion of a conductive member, the conductive member being connected to the terminal on a conductor welding surface of the terminal, the manufacturing method including:
forming at least one of a convex portion and a concave portion on the conductor welding surface; and
connecting the conductive member to the conductor welding surface by means of ultrasonic welding.

2. The welded body manufacturing method according to claim 1,
wherein the metal base material is tin-plated.

3. The welded body manufacturing method according to claim 1 further including:
plating an entirety of the terminal after the forming.

4. The welded body manufacturing method according to claim 1 further including:
performing a reflow processing on the terminal before the connecting.

5. The welded body manufacturing method according to claim 1,
wherein the conductive member is a core wire of an electric wire, the core wire being covered with an outer cover.

6. The welded body manufacturing method according to claim 5,
wherein the at least one of the convex portion and the concave portion is formed in a linear shape extending in a direction intersecting a longitudinal direction of the core wire.

7. A welded body comprising:
a terminal formed of a metal base material and having a conductor welding surface on which at least one of a convex portion and a concave portion is formed, the terminal being plated with a metal material having a hardness lower than a hardness of the metal base material; and
a conductive member welded and connected to the conductor welding surface of the terminal.

8. The welded body according to claim 7,
wherein the metal base material is tin-plated.

9. The welded body according to claim 7,
wherein the conductive member is a core wire covered with an outer cover.
